(19) United States
(12) Patent Application Publication
(10) Pub. No.: US 2006/0011125 A1
(43) Pub. Date: Jan. 19, 2006

(54) Bookmark for opening a book to a selected page

(76) Inventor: John R. Polly, Moorpark, CA (US)

Correspondence Address: ROBERT L. FINKEL, P.O. BOX 19276, ENCINO, CA, 91416-9276, US

(21) Appl. No.: 10/856,922

(22) Filed: Jul. 19, 2004

(51) Int. Cl. B42D 9/00

(52) U.S. Cl. 116/234

(57) ABSTRACT

This bookmark employs suitable conventional permanent attachment methods, such as sewing or gluing, or temporary means, such as VELCRO® hook and loop pads, a resilient metal or plastic clip or an adhesive-backed tab, to secure one end of an elongated support element of string, thread, filament or ribbon to the spine, cover or page of a book near its upper edge. A spreader, for example, a button, bead, block, strip or other convenient object of suitable form and thickness is tied, sewn, glued, or otherwise secured to the other end of the support element. The support element is sized to position the spreader from about ¼ of an inch to about 2 inches from the lower edge of the pages when the spreader is inserted between selected adjacent pages of the book and allowed to hang freely. When the book is closed, the spreader forces the adjacent pages apart to provide a well-defined opening at the page's lower edges thereby not only clearly showing the reader the selected place in the book, but also providing him or her means for readily opening the book at that place.

### BACKGROUND OF THE INVETION

1. Field of the Invention

This invention relates to bookmarks. More particularly, it is directed to a bookmark that not only marks a selected page in a book but, in addition, facilitates the reader's opening of the book to the selected page.

2. Prior Art

As long as there have been books too long to read in a single sitting, methods and means have been needed for marking the reader's place. The method of binding leaves of vellum bearing writing in the fashion of the modern book is believed to have originated in about the second century A.D. Archeological records indicate that the earliest of these were provided with strips of material of some sort adapted to be placed between the pages. Over the ensuing millennia, as the art and technology of printing and binding have advanced, the craft and technique of providing the reader with means for marking a page in a book to which he or she wishes to return at a later time have advanced as well.

As Farrington, U.S. Pat. No. 5,375,884 elucidates in detail, from the simplest “dog-eared” page corner to elaborate devices having numerous working components which must be made, assembled, and secured together, the prior art is replete with devices for marking a selected page in a book. Farrington provides examples of no fewer than 13 different methods and means for attaching bookmarks to books. U.S. Pat. No. 5,439,254 to Dorion, U.S. Pat. No. 5,515,809 to Weinberg, and U.S. Pat. No. 6,109,204 to Hoey, et al., U.S. Design Pat. Nos. Des. 314,589 to Cooley and Des. 453,185 to Kehrein and U.S. application 2002/0158462 to Antoine N. E. and P.C.T Application No. PCT/US82/01104 of Zeisky, disclose additional examples of bookinarkers and methods for making and using them. These references and those cited by Farrington represent a comprehensive cross-section of the prior art with regard to bookmarks and bookmarking devices and methods.

Interestingly, despite their breadth and disparity, all of these prior art bookmarks fall into one of two categories. In one, a rigid or resilient mechanism or component that serves as a partition is adapted to be positioned between the page to be marked and the page adjacent to it, effectively preventing the book from being opened at any other place than the selected one. U.S. Pat. No. 6,109,204 and PCT/US82/01104 are typical of such devices. By and large, bookmarkers of this type are cumbersome and difficult to use. More importantly, because they generally employ interacting moving parts, they exhibit a marked, unacceptable propensity to damage the book cover, binding and pages.

The second, far more common type of bookmark comprises an elongated, flexible, generally flat or thin page marker adapted to be inserted between adjacent pages in a book and means for attaching the marker to the spine, binding, cover or pages of the book. The marker may be a string, thread, filament, ribbon, strip, card, cable, chain or other suitable construction, may be of natural or synthetic composition, and may take virtually any configuration. Bookmarks of this type are designed to allow the flexible marker to be placed between adjacent pages in a book with the end of the marker extending below the edge of the pages as a visible indication of the reader's place. To open the book at that place, the reader holds the volume in one hand, grasps the exposed end of the marker with the fingers of his other hand, and applies force substantially normal to the pages, effectively prying the adjacent pages apart.

For many readers, the free end of the marker is difficult to locate, elusive to grasp, and awkwardly challenging to grip tightly enough to separate the pages. The task becomes increasingly difficult as the marker becomes worn with use. For the visually impaired and the physically handicapped, the use of such markers often is beyond his or her capability.

In recognition of the difficulty posed by locating and grasping the exposed end of the conventional bookmark, some prior art markers are provided with enlargements or other grasping means at their exposed lower end. U.S. Pat. Nos. 5,375,884 and 5,022,342 are examples of such adaptations. While these features may facilitate the reader's finding and gripping the marker, they do not eliminate the need to apply the necessary force at the proper angle to separate the pages.

Clearly the art is replete with devices for marking the reader's place in a closed book Likewise, ample alternative means are available for attaching these devices to a book. It would be desirable, now, to provide a readily attachable bookmark that not only allows the reader to locate his or her page, but additionally facilitates his or her opening the book at that page.

### OBJECTS OF THE INVENTION

Given the state of the prior art, one of the objects of the subject invention is the provision of a family of bookmarks adapted for insertion between a selected page and an adjacent page of a book to not only mark the selected page but to facilitate the opening of the book to the selected page as well.

Another object of the invention is to provide bookmarks having the aforementioned characteristics that neither suffer nor cause any undesirable result when inserted and left in place between the pages of a book.

The subject invention has for another of its objects the provision of a novel bookmarker of the type described that is inexpensive to manufacture and requires little, if any, skill or effort to use.

Yet another object of the invention is the provision of an improved book-marker of the type described here that avoids or overcomes the various defects and deficiencies of the prior art markers.

Still another object is the provision of a bookmarker construction capable of being adapted to or incorporated in bookmarkers of substantially all of the conventional configurations presently in use.

Still a further object of this invention is the provision of a bookmarker adapted to be attached to a book, the bookmarker comprising a spreader for spreading adjacent pages in the book, an elongated support element extending from the spreader and book-engaging means attaching the support element to the book, the book-engaging means positioning the spreader at the lower ends of a selected page and the page adjacent the selected page of a book, whereby a region of the lower edge of the selected page and a corresponding region of the lower edge of the adjacent page are spread apart when the book is closed.

Other and farther objects will become apparent from a reading of the following summary and detailed description of the invention.

### SUMMARY OF THE INVENTION

The present invention is directed to a bookmark comprising three components: a spreader for spreading adjacent pages in a book, an elongated support element extending from the spreader, and attachment means for attaching the support element to a book. The attachment means may embody any of the well-known methods for securing a marker to the book. For exemplary purposes here, the attachment means takes the form of a VELCRO® or similar fastener comprising a pair of corresponding tabs having minute interlocking hooks and loops on their respective confronting surfaces. One of the tabs is provided with an adhesive backing which allows it to be attached, hook or loop side facing outwardly, to the spine or cover of the book near the book's upper edge. The other tab has tied, sewn, glued or otherwise attached at its upper edge one end of the supporting element, which, for illustrative purposes may be a string, thread or filament of flexible material. The spreader, for example, a button, bead, bauble, trinket, ornament or other convenient mass, is tied, sewn, glued or, otherwise secured to the other end of the supporting element. The spreader may be of any suitable size and esthetically appealing shape. The support element is sized to position the spreader from about a quarter of an inch to about two inches from the bottom edge of the pages when the marker is inserted between adjacent pages of the book and allowed to hang freely.

I have discovered that even a relatively thin, flat spreader when it is positioned near the bottom edges of the book's pages forces the adjacent pages apart to provide a well-defined opening at the pages' bottom edges into which the reader can easily insert a thumb or finger. This opening not only clearly shows the reader the selected place in the book, but also provides him or her convenient means for opening the book at that place.

### BRIEF DESCRIPTION OF THE DRAWING

FIGS. 1-4 are illustrative of several typical forms of prior art bookmarks;

FIGS. 5a and 5b illustrate a booklet containing a bookmark in accordance with the subject invention;

FIGS. 6a through 6d illustrate typical examples of articles that may serve as spreaders in the practice of the subject invention;

FIG. 7 illustrates the appearance and operation of a typical hardcover book incorporating an embodiment of the subject invention; and

FIG. 8 illustrates an alternative method and means for attaching the support element and spreader of the subject invention to a book.

Wherever practicable, like numerals are employed to designate like or functionally equivalent parts of the several figures.

### DETAILED DESCRIPTION OF THE PREFERRED EMBODIMENTS

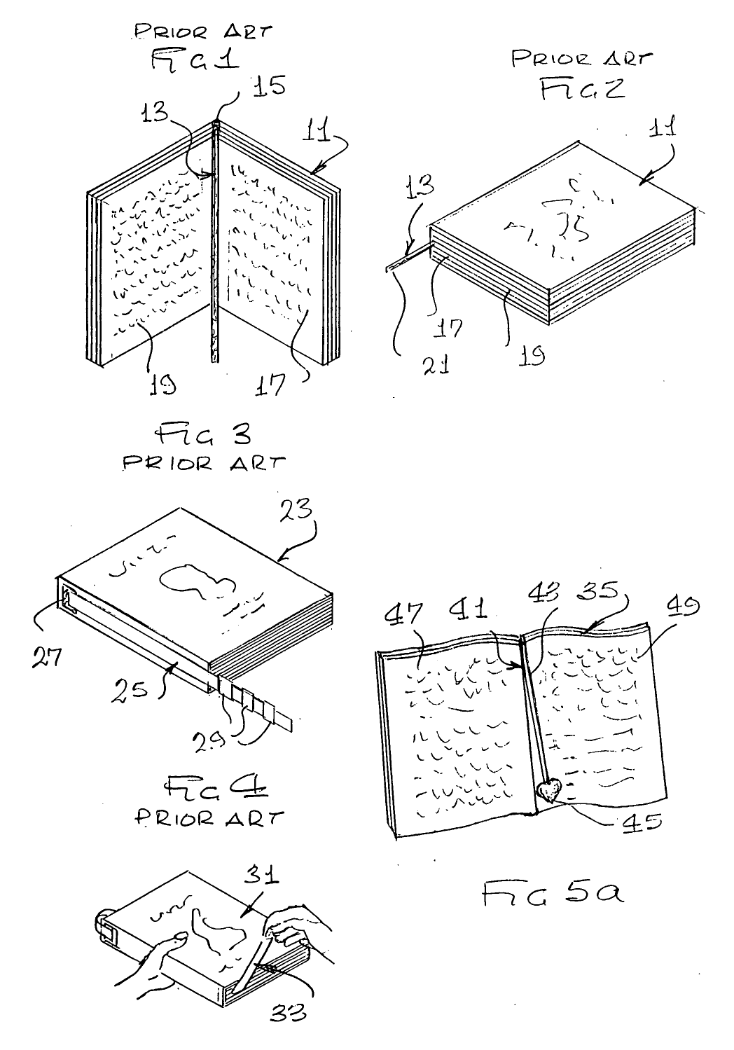

Referring to the drawing, FIGS. 1-4 illustrate typical bookmarks and features well known in the art. FIG. 1 shows a hard cover book 11 with a cloth ribbon 13 sewn or glued to the top (upper portion) of the binding 15. For descriptive purposes, the book is shown open at the last page read by the reader, designated by the numeral 17, and the adjacent page, designated by the numeral 19.

In FIG. 2, the book 11 shown in FIG. 1 is closed. The lower end 21 of ribbon 13 extends below the bottom edges of the pages of the book and marks the reader's place between the adjacent pages 17, 19.

FIG. 3 shows a conventional paperback volume 23 to which a bookmark in the form of a cord 25 is attached by means of an adhesive-backed tab 27 applied to the cover near the top of the spine. Conventionally, the cord is attached to the top of the tab 27 for insertion between any pair of adjacent pages. Unlike the flat, unadorned ribbon 13 of FIGS. 1 and 2, cord 25 is provided with sliding markers 29 adapted to convey information concerning the text to the reader. To my knowledge no mention has ever been made in the prior art that protrusions on a bookmark, such as marker 29, might create an opening in the bottom edges of the pages of a book or might serve in any way to mark, or facilitate the opening of a book at the reader's place.

FIG. 4 illustrates the manner in which the prior art book 31 is commonly grasped in the reader's left hand and opened to the selected place by an upward pull with the user's right hand on the end of bookmark 33.

FIG. 5a illustrates a bookmark embodying the subject invention. Here the book is shown is in the form of a booklet 35 made up of a number of folded pages stapled together in a soft paper cover. In this instance, the bookmark employs a support element 41 in the form of a nylon filament 43 attached to the cover of the book at the top of the folded binding by means of an adhesive pad (not shown).

A spreader 45 in the form of a heart shaped ornament of molded resin, polished stone or other suitable material is suspended on support element 41 at a point near the bottom of adjacent pages 47, 49.

FIG. 5b depicts the effect of the positioning of the spreader 45 near the lower edge of the pages designated 47, 49 when the booklet 35 is closed. As will be noted, in actual practice the presence of the spreader 45 and its interaction with pages 47, 49 and a certain number of pages on either side of them causes an opening 51 to be formed in the plane containing the bottom edges of the pages of the book. The size and shape of the opening are determined by the dimensions, configuration, surface characteristics and positioning of the spreader 45 and may be adjusted by judicious selection of those features.

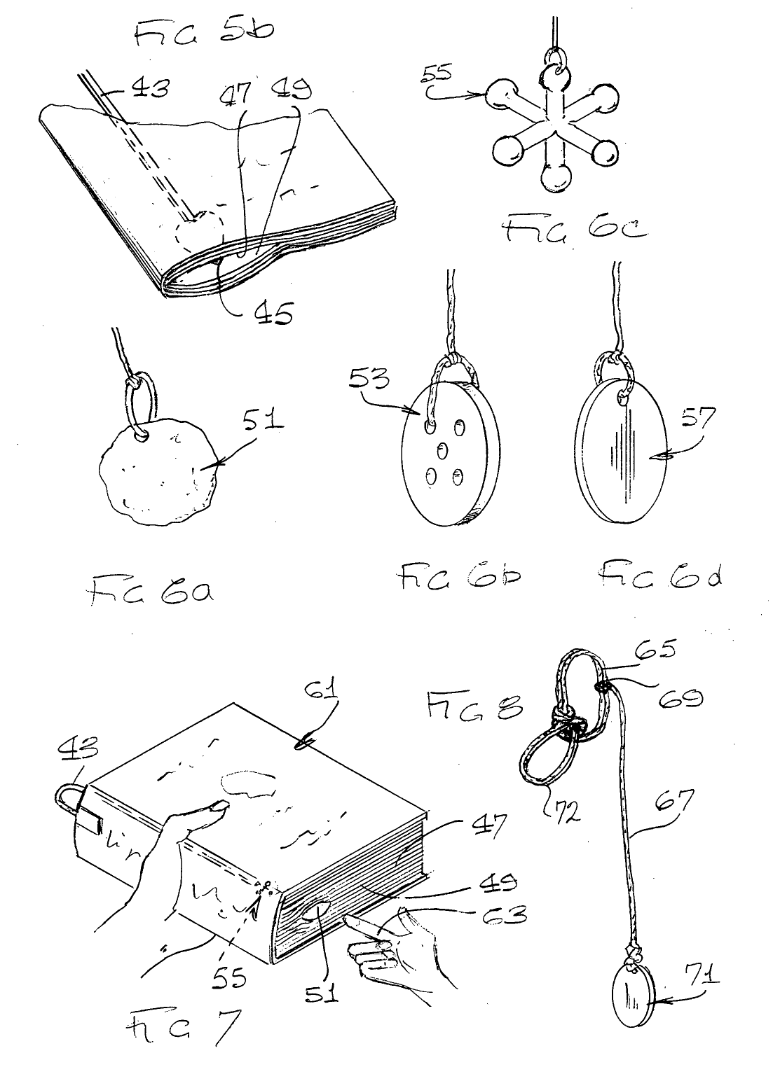

The spreader 45 may be of any suitable material and may take a variety of forms. FIGS. 6a-6d are offered to illustrate the diversity of sizes, configurations and materials suitable for the invention's purpose. The spreader, object 51 in FIG. 6a, may be a common beach pebble, a polished semi-precious gem, a work of sculpture that happens to appeal to the reader's esthetic sense. The mass 53 in FIG. 6b is a common button. In FIG. 6c, a whimsical game piece in the form of a miniature jack 55 is depicted. And as seen in FIG. 6d, even a low-power magnifying glass 57 suitable for reading the printed page can be used to locate and gain access to the page.

In practice, I have found the selection of the spreader and the dimensioning of the support element to be easily accomplished by trial and error. As a rough guide, however, my efforts suggest that for best results with conventionally bound booklets, standard mass market and trade paperback books and standard hard cover books the spreader should be from about ⅛ inch to about ⅜ inch, and preferably about 3/16 inch in thickness. For books on heavier stock, such as books in Braille, a larger spreader, in the range of from about ¼ inch to about ¾ inch, and preferably about ⅜ inch thick is more effective in producing the desired opening in the bottom of the pages.

Although the invention is illustrated in FIG. 5a and b in use with a booklet type binding, the invention is equally applicable to hard cover and paper back books. Likewise, it is as adaptable to plastic comb and coil, spiral wire, glue/perfect, velo, thermaltape and conventional glued and sewn bindings as it is to folded and stapled or stitched bound pages.

FIG. 7 is illustrative of the function of the subject invention in a hard cover volume 61 300 or 400 pages in length. For exemplary purposes, a miniature jack 55, such as that shown in FIG. 6c, is utilized as the spreader and suspended at the end of elongated support element 43. As with the booklet of FIGS. 5a and 5b, the presence of spreader 55 creates an opening 51 between the adjacent pages 47, 49. Opening 51 not only shows the reader his or her place, but facilitates the opening of the book to the designated page. Holding the book in his left hand, all the reader need do is insert the first finger of his right hand into opening 51 and with a minimum of force rotate the page 49 and the pages preceding it in a counterclockwise direction until the book is lying open in the palm of the reader's left hand.

In like manner, the subject invention causes an opening to be formed in the bottom of the adjacent pages of a paperback book on either side of the spreader. It will be noted that in each instance the opening between the pages in the bottom of the book is substantially easier for the visually impaired or physically incapacitated reader to find and use to open the book than the end of a bookmark ribbon protruding from the bottom of the book. This feature is particularly useful to those who read books in Braille.

FIGS. 5a, 5b and 7 illustrate embodiments of the subject invention utilizing conventional adhesive tabs and spring clips as book-engaging means for attaching the support element to the book. FIG. 8 illustrates an embodiment of the invention in which the attachment means takes the form of an elastic rubber band 65 sized to encircle the binding of the book between a pair of centrally-located adjacent pages. This inexpensive, easily replaceable device would be most useful for mass-market publications, such as TV Guide and Readers Digest. For booklets of the size of those publications, the elastic band can be from about 5 inches to about 5½ inches in length. The support element 67 is secured to rubber band 65 by means of a conventional girth hitch or similar knot 69 which, in combination with the resilience of the band 65 allows spreader 71 to be positioned for optimum effect at the lower portion of the selected page.

It will be understood without need for illustration that the subject invention contemplates providing the reader with the broadest possible selection of spreaders, support elements and attachment means to achieve the desired results.

It will likewise be understood that because the principle underlying the invention is not fully understood, it has been necessary in describing certain of the features, such as the length of the support element and the dimensions, configuration and surface of the spreader, to employ empirical rather than absolute terms. The nature and operation of the invention are such, however, that the parameters of the several features are readily discernable by those skilled in the art with a minimal amount of effort.

The utility and benefits afforded by the invention will be readily apparent from the foregoing disclosure. It should be understood, however, that although the invention has been disclosed in terms of the specific constructions shown in the Drawing and described in the text, it is not to be construed as limited to those embodiments. They are to be regarded as illustrative rather than restrictive. This specification is intended to encompass any and all variations, alternative forms, and equivalents of the examples chosen for purposes of the disclosure, which do not depart from the spirit and scope of the invention as it is defined by the following claims.

What is claimed is:

1. A bookmark, comprising:
a spreader for spreading adjacent pages in a book;
an elongated support element extending from said spreader; and
book-engaging means for attaching said support element to the book, said book-engaging means positioning said spreader at the lower ends of a selected page and the page adjacent the selected page of a book, whereby a region of the lower edge of the selected page and a corresponding region of the lower edge of the adjacent page are spread apart, thereby marking and facilitating the opening of the book at the selected page.

2. The bookmark of claim 1, wherein said support element is flexible.

3. The bookmark of claim 2, wherein said book-engaging means adjustably attaches said support element to the book

4. The boolkmark of claim 3, wherein said book-engaging means attaches said support element to the spine of the book.

5. The bookmark of claim 4, wherein said book-engaging means comprises an elastic band positioned between adjacent pages of the book and encircling the spine of the book.

6. The bookmark of claim 5, wherein said support element is attached to the elastic band.

7. The bookmark of claim 3, wherein said book-engaging means releasably attaches said support element to the book.

8. The bookmark of claim 7, wherein said book-engaging means comprises an adhesive backing.

9. The bookmark of claim 7, wherein said book-engaging means comprises mating hook and loop elements.

10. The bookmark of claim 3, wherein said book-engaging means comprises a resilient clip mounted to the spine of the book.

11. The bookmark of claim 3, wherein said book-engaging means is selectively adjustable for use of the bookmark with standard mass market paperback books, standard trade paperback books and standard hard cover books.

12. The bookmark of claim 1, wherein the spreader is from about ⅛ inch to about ⅜ inch thick.

13. The bookmark of claim 12, wherein the spreader is about 3/16 inch thick.

14. The bookmark of claim 1, wherein the spreader is from about ¼ inch to about ¾ inch thick.

15. The bookmark of claim 14, wherein the spreader is about ⅜ inch thick.

16. The bookmark of claim 6, wherein the elastic band is from about 5 inches to about 5½ inches in length.

17. The bookmark of claim 6, comprising a book-encircling elastic band attached to the book-engaging elastic band, for encircling a book and thereby preventing the book from opening unintentionally when not in use.
